(19) United States
(12) Patent Application Publication
(10) Pub. No.: US 2006/0196913 A1
(43) Pub. Date: Sep. 7, 2006

(54) Assembly tool for positioning of a chassis component and corresponding manipulating device

(76) Inventor: Thomas Zirbs, Weil der Stadt (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/543,547

(22) PCT Filed: Mar. 26, 2003
(86) PCT No.: PCT/EP03/03120

§ 371 Date: Jul. 27, 2005

(30) Foreign Application Priority Data
Jan. 30, 2003 (DE) 103 03 844.2

(51) Int. Cl. B23K 37/00

(52) U.S. Cl. 228/44.3; 228/47.1

(57) ABSTRACT

The assembly tool (10) for a manipulating device (12) serves to position a body component (14) at a vehicle body (16) while forming bearing contact, the assembly tool (10) being provided with a gripping mechanism (18) and with a positioning mechanism (20), and the positioning mechanism (20) being suitable for initiating a bearing force in the body component (14). In this case, provision is made for the positioning mechanism (20) to contain at least one shaped element (22), the component contact surface (24) of which is adapted in shape with regard to a desired component contour for forming bearing contact, favorable for fastening, between the body component (14) and the vehicle body (16).

### BACKGROUND OF THE INVENTION

1. Field of the invention

The invention relates to an assembly tool for a manipulating device for positioning a body component at a vehicle body while forming bearing contact, the assembly tool being provided with a gripping mechanism and with a positioning mechanism, and the positioning mechanism being suitable for initiating a bearing force in the body component, according to the preamble of claim 1. The invention also relates to a manipulating device according to the preamble of claim 17.

2. Related Art of the Invention

Assembly tools and manipulating devices of the type mentioned at the beginning are known. DE 101 21 344 A1 discloses a gripping device for gripping articles, for example motor vehicle windshields or body parts, by means of a robot arm. To this end, the gripping device is provided with a carrier which has a plurality of suction grippers. With suitable movement of the robot arm, an article adhering to the suction grippers can be arranged in a predetermined assembly position relative to a vehicle body while forming predeterminable bearing contact. The bearing contact is created by initiating a bearing force in the article, bearing against the vehicle body, by the rotor arm.

### SUMMARY OF THE INVENTION

An object of the invention is to provide an assembly tool of the type mentioned at the beginning which enables correct bearing contact to be made between the body component and the a suitable manipulating device for use of the assembly tool.

To achieve the object, an assembly tool having the features of claim 1 is proposed. The assembly tool according to the invention is characterized in that the positioning mechanism contains at least one shaped element, the component contact surface of which is adapted in shape with regard to a desired component contour for forming bearing contact, favorable for fastening, between the body component and the vehicle body. It is therefore possible by means of the shaped element to at least promote the formation of optimized bearing contact between the vehicle component and the vehicle body by the positioning mechanism of the assembly tool according to the invention, so that the body component can be correctly fastened to the vehicle body with ease of assembly. To this end, a desired bearing force can be transmitted by means of the shaped element into the body component to be correctly positioned at the vehicle body. In this case, it is especially favorable that the component contact surface of the shaped element is adapted in shape to a desired contour of the body component, so that the same can be pressed by means of the shaped element against the vehicle body in a surface region which is favorable with regard to the initiation of bearing force, with bearing contact favorable for fastening being formed. Here, “bearing contact” can be produced directly between the intended contact surfaces of the body component and the vehicle body or alternatively, or additionally, between, for example, an adhesive intermediate layer and one of said construction units (body component, vehicle body). If need be, one or more elastic spacers—for example made of rubber—may also be arranged as stop elements between these construction units in order to ensure that the body component is spaced apart from the vehicle body in a defined manner, at least in sections, when corresponding spacer bearing contact is produced, in order to form, for example, an intermediate space defined in terms of height for accommodating an adhesive layer in a manner favorable for fastening.

The contour of the component contact surface of the shaped element advantageously corresponds to the outer surface contour of a ready-assembled body component. This ensures that the body component in bearing contact with the vehicle body is correctly positioned in terms of shape and thus reliable fastening of the same body component to the vehicle body is possible. In this case, it may possibly be sufficient for the component contact surface of the shaped element to correspond to merely a partial contour of the outer surface of the ready-assembled body component.

The shaped element is preferably arranged in an adjustable and/or interchangeable manner in the positioning mechanism for adapting the contour of the assembly tool to geometrically different designs of the body component. It is thus possible with the same assembly tool to position geometrically different body components at an associated vehicle body and fasten them thereto if need be. It is therefore not necessary to provide a separate assembly tool for-every design of a body component.

According to a preferred embodiment, the positioning mechanism has a plurality of shaped elements arranged at a distance from one another. The shaped elements may be arranged at locations of the body component which are critical in terms of fastening in order to ensure that completely correct bearing contact is formed between body component and vehicle body.

In a development of the invention, at least one shaped element is displaceable and/or pivotable in position relative to a shaped-element carrier system. This enables the geometry of the shaped contact area, consisting of the component contact surfaces of the shaped element, of the assembly tool to be adapted to the outer surface contour of the body component (desired component contour) in an easy-to-manipulate manner. In this case, the desired component contour, during the assembly process, preferably corresponds to the ideal contour of the ready-assembled body component. Furthermore, if appropriate, a respective shaped element can be brought into an active assembly position or into an inactive rest position, so that geometric adaptation of the shape of the assembly tool with regard to shaped elements which can be located in an active position of use is possible in this way.

The shaped-element carrier system advantageously contains a tool carrier unit, to which the shaped elements are fastened and which in turn is mounted in a floating manner on a carrier unit of the manipulating device, it being possible for the floating mounting to be activated and deactivated. The floating mounting serves to ensure automatic centering of the tool carrier unit and thus of the shaped elements and possibly of further functional elements, such as gripping elements for example, at suitable assembly instants. To this end, the assembly tool may be provided, if appropriate, with an orientation system, for example in the form of a projecting bearing element. Furthermore, the floating mounting can be activated and can thus come into effect in particular when carrying out a fastening or connecting process in which a relative movement is necessary between the body component and the manipulating device.

The shaped elements are advantageously connected to the tool carrier unit by means of at least one spring element, for example in the form of a spring lever. The spring-mounted attachment of the shaped elements to the tool carrier unit makes it possible to produce desired contact during the positioning operation between the body component and the shaped elements even in the case of existing tolerances of form and/or position of the body component or of the vehicle body. The contact occurs automatically here preferably over the entire component contact surface of the respective shaped element.

The tool carrier unit and the carrier unit of the manipulating device may each be designed as a frame extending in the longitudinal direction and the transverse direction of the assembly tool. In this way, the assembly tool is designed in a sufficiently dimensionally stable manner and at the same time ensures flexible adaptation of the position of the shaped elements to the outer surface contour of the body component to be assembled.

In accordance with a preferred embodiment, at least two shaped elements are connected to one another while forming a shaped-element group, it being-possible for one shaped element to be located in an active operating position and the other shaped element in a passive rest position by means of a suitable adjusting movement of the shaped-element group. In this case, the adjusting movement of the shaped-element group may be a pivoting movement and/or a reciprocating movement. The adjusting movement may be automated or initiated manually. An associated body component can therefore be positioned correctly relative to a vehicle body by means of the assembly tool by locating associated shaped elements in their respectively active operating position, it being possible, by means of a suitable adjusting movement of the respective shaped-element group, for a body component version having a changed outer surface geometry to also be correctly positioned with the same assembly tool in order to produce defined bearing contact with an associated vehicle body.

The shaped elements forming a shaped-element row are advantageously arranged relative to one another in a longitudinal direction conforming to the component and/or in a transverse direction conforming to the component. The arrangement of the shaped elements relative to the body component may be established as a function of the component geometry and/or of requirements imposed on the connection between the body component and the vehicle body, if need be differently for each component variant. The shaped elements are arranged in particular in one or more component marginal regions, since the body component is fastened to the vehicle body in these regions as a rule.

The shaped elements are preferably stop elements for producing a defined adhesive-bead pressing force when surface contact is produced between the component contact surface and the outer surface of the body component to be adhesively connected to the vehicle body. To produce a correct adhesive connection between the body component and the vehicle body, it is important that bearing contact favorable for adhesive is produced between said connecting parts. In adhesive connections, it is important to press the adhesive beads uniformly between the body component and the vehicle body, so that a sufficiently high adhesive force can act between the parts to be connected. This is ensured by the suitably arranged shaped elements, adapted to the respective contour of the body component, for producing favorable bearing contact between the parts to be connected.

The assembly tool may have an adjusting mechanism for the automated adaptation of the contour of the component contact surface by assuming a defined active operating position. If need be, the adjusting mechanism may be connected to a body-component recognition system of the assembly tool. This permits rapid and reliable assembly of body components of different geometry by means of a suitably adapted assembly tool.

The gripping mechanism is advantageously designed as a suction gripping mechanism. A suction gripping system for assembly purposes is known per se and is reliably used for the reliable gripping and positioning of the most varied body components.

The assembly tool may advantageously be used as a roof-module assembly tool. Component versions of different shape are used in particular, in modular design in vehicle construction, so that the assembly tool according to the invention can be used in an especially flexible manner. In this case, adhesive connections are also being provided more and more often for fastening a roof module to a vehicle body. Furthermore, the assembly tool is also suitable for positioning glass roof modules at a vehicle body. The shaped elements are advantageously produced from a surface-protective material in order to prevent undesirable assembly damage, for example of a painted and thus especially sensitive module outer surface.

Furthermore, the object is achieved by a manipulating device having the features of claim 17, the manipulating device according to the invention being designed as an assembly robot. The use of assembly robots in the vehicle production industry is known, so that recourse to novel manipulating devices need not be had for the use of the assembly-tool according to the invention. By means of a single assembly robot, a multiplicity of different construction variants of body components can be reliably positioned or assembled at a respectively associated vehicle body when using the assembly tool according to the invention. Alternatively, however, it is also conceivable to position a body component at a vehicle body at least partly manually by means of the assembly tool according to the invention.

Further advantages of the invention follow from the description.

### BRIEF DESCRIPTION OF THE DRAWINGS

The invention is explained in more detail with reference to several preferred exemplary embodiments and a schematic drawing.

In the drawing:

FIG. 1 shows a schematic perspective illustration of part of an assembly tool according to the invention;

FIG. 2 shows a further schematic perspective illustration of part of the assembly tool according to the invention in FIG. 1;

FIG. 3 shows a further schematic perspective illustration of part of the assembly tool according to the invention in FIG. 2;

FIG. 4 shows a schematic side view of a partly shown assembly tool according to the invention in a second embodiment during operational use;

FIG. 5 shows a schematic front view of part of the assembly tool of FIG. 4;

FIG. 6 shows a schematic side view of an assembly tool according to the invention in a third embodiment;

FIG. 7 shows a schematic front view of the assembly tool according to the invention in FIG. 6;

FIG. 8 shows a schematic side view of an assembly tool according to the invention in a fourth embodiment;

FIG. 9 shows a schematic side view of an assembly tool according to the invention in a fifth embodiment;

FIG. 10 shows a schematic detailed illustration of a shaped element of an assembly tool according to the invention;

FIG. 11 shows a schematic side view of an assembly tool according to the invention in a sixth embodiment;

FIG. 12 shows a schematic side view of a shaped element of an assembly tool according to the invention, and

FIG. 13 shows a schematic front view of the shaped element in FIG. 12.

### DETAILED DESCRIPTION OF THE INVENTION

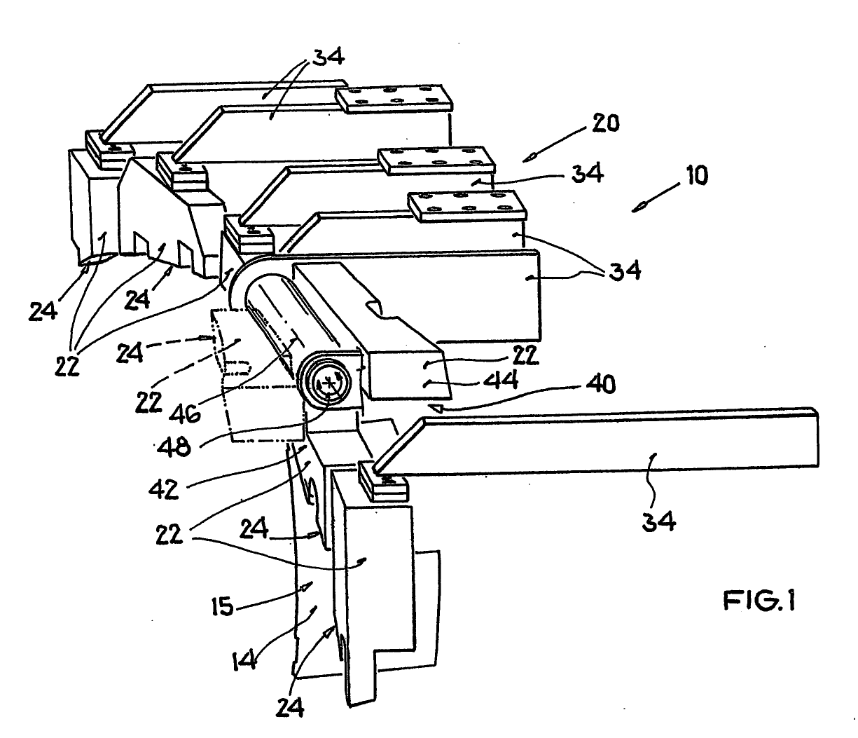

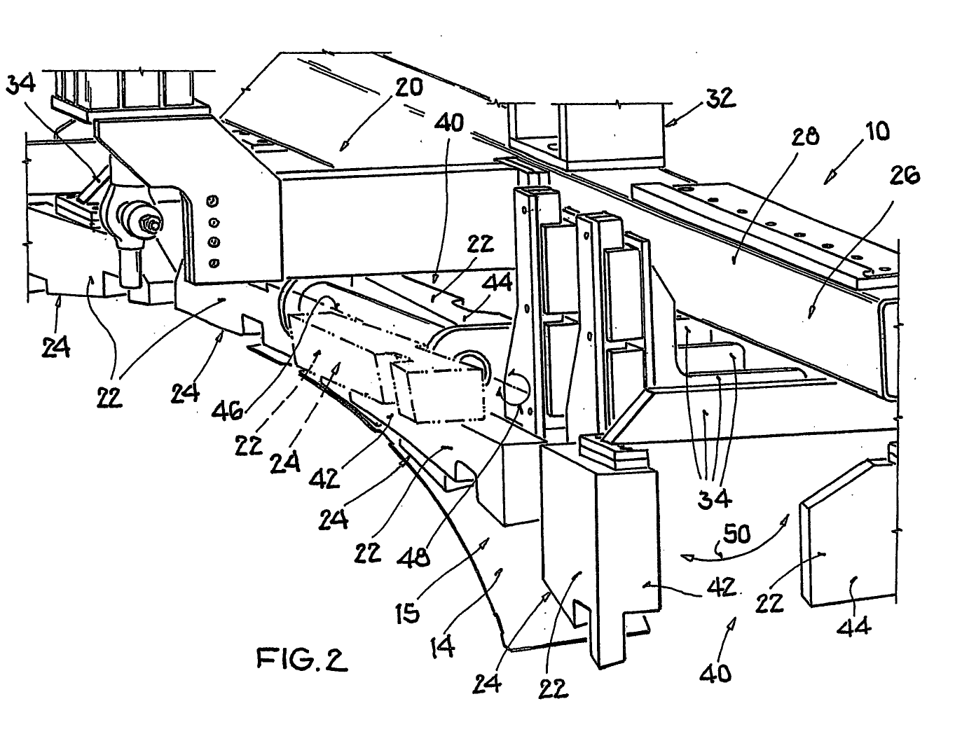

FIGS. 1 to 3 show different perspective partial illustrations of an assembly tool 10 according to the invention in a first embodiment, this assembly tool 10 serving to position a body component 14, for example in the form of a roof module, at a vehicle body (not shown in FIGS. 1 to 3). In this case, bearing contact is to be produced between the body component 14 and the vehicle body during the positioning operation. The assembly tool 10 is provided with a positioning mechanism 20 which is suitable for initiating a bearing force on sections of an outer surface 15 of the body component 14 when producing the bearing contact. To this end, the positioning mechanism 20 contains a plurality of shaped elements 22 arranged at a distance from one another. Each shaped element 22 has a component contact surface 24 which is adapted with regard to a desired component contour shape. In this case, the expression “desired component contour” refers to the contour of a body component 14 ready assembled correctly on the vehicle body. The shaped elements 22 serve to form bearing contact, favorable for fastening, between the body component 14 and the vehicle body during the component assembly on the vehicle body. Furthermore, the assembly tool 10 contains a shaped-element carrier system 26 (see FIGS. 2 and 3), which has a tool carrier unit 28, to which the shaped elements 22 are fastened with a respective spring element 34 in the form of a spring lever in between.

The assembly tool 10 shown in FIGS. 1 to 3 contains two shaped-element groups 40 which in each case have two shaped elements 22 with component contact surfaces 24 different from one another. One shaped-element group 40 is in this case pivotable about the rotation axis 46 (see FIGS. 1 and 2) according to the rotation double arrow 48 shown in such a way that an active shaped element 42 is arranged in a defined operating position and the other inactive shaped element 44 is arranged in a defined rest position. The second shaped-element group 40, on the other hand, is pivotable about a suitable rotation axis according to double rotation arrow 50 (see FIGS. 2 and 3), so that, here, too, an active shaped element 42 is arranged in a defined operating position and an inactive shaped element 44 is arranged in a defined rest position. During appropriate pivoting of the shaped-element groups 40, in each case one of the two shaped elements 22 connected to one another can therefore be brought into an active operating position or into an inactive rest position. It is therefore possible to suitably adapt the assembly tool 10 to the contour of geometrically different designs of the body component 14. Furthermore, according to a further embodiment, it is additionally or alternatively possible to displace the second shaped-element group 40 according to the broken double arrow 51 (see FIG. 3) along the tool carrier unit 28, the second shaped-element group 40 in this case consisting of two continually active shaped elements 22 which are arranged at an angle to one another and are correspondingly adjusted in position for positioning, for example, a short or a long embodiment of a body component 14. If need be, further shaped elements 22 arranged in the longitudinal and/or transverse direction can be fastened to the tool carrier unit 28 in such a way as to be adjustable in position, or can be interchangeable. The shaped element 22 shown by broken lines in FIGS. 1 and 2 therefore corresponds to the active shaped element 42 if the same, with suitable pivoting of the shaped-element group 40 about the rotation axis 46, is pivoted into the defined rest position, whereas the inactive shaped element 44 shown in FIGS. 1 and 2 is then in the defined operating position. Such an adjustment of the shaped-element group 40 may be effected in an automated manner by means of an adjusting motor 52 (see FIG. 3), for example in the form of an electric motor. The carrier unit 28 of the assembly tool 10 according to FIGS. 1 to 3 can be connected to a suitable manipulating device (not shown in FIGS. 1 to 3) with a floating mounting 32 in between. In this case, the floating mounting 32 can be activated and deactivated by means of a suitable system, the carrier unit 28 of the assembly tool 10 being connected to the manipulating device in a Notionally rigid manner upon deactivation.

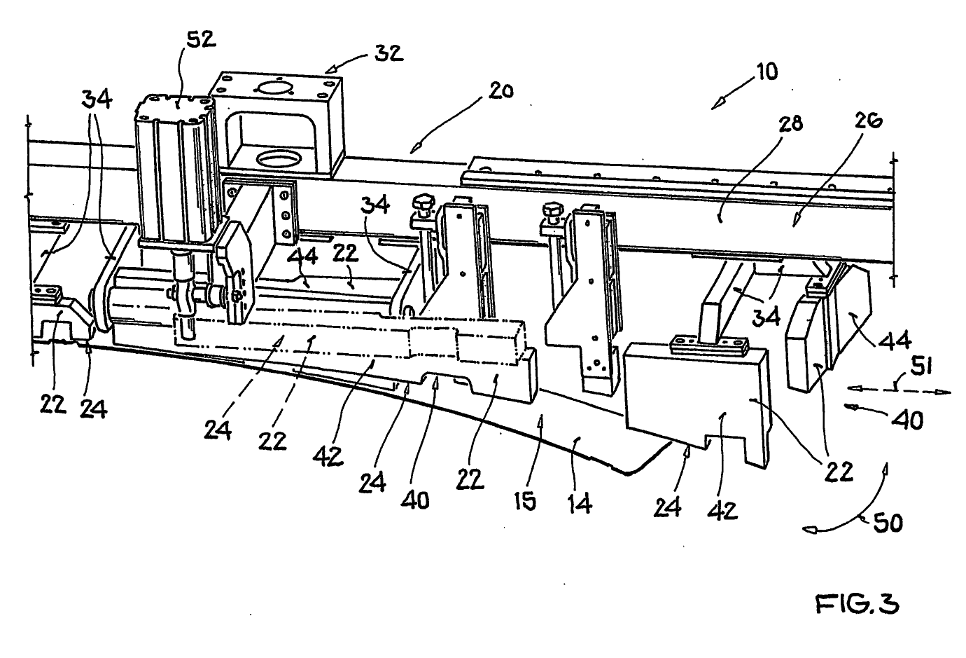

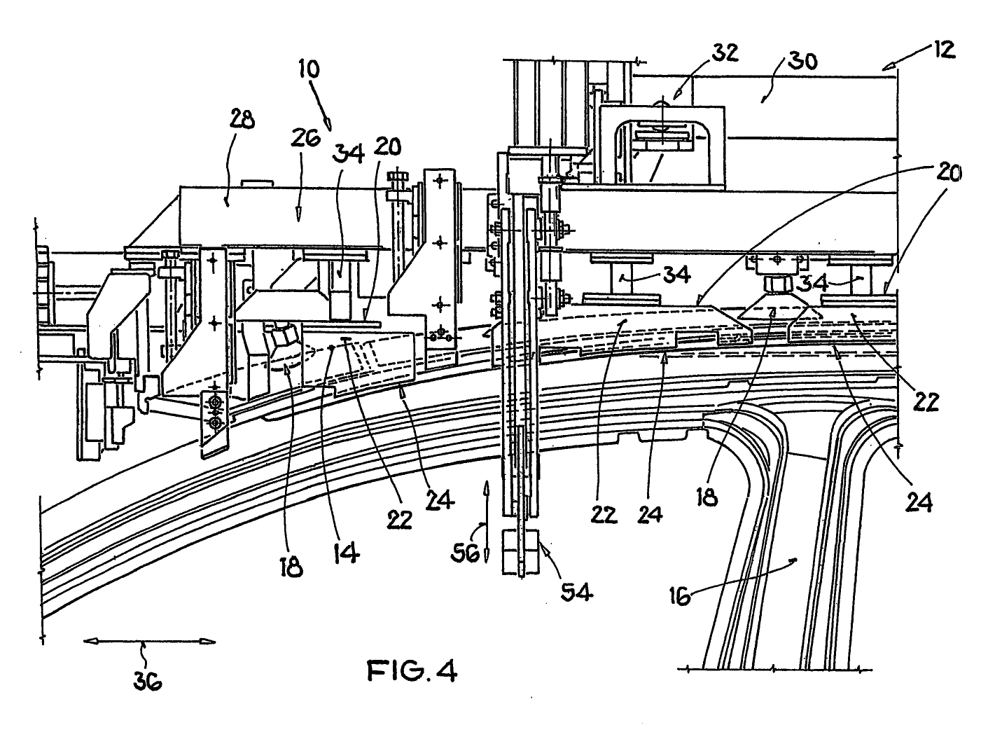

FIGS. 4 and 5 show a second embodiment of an assembly tool 10 according to the invention in use. A gripping mechanism 18 of the assembly tool 10 is shown in FIGS. 3 and 4, this gripping mechanism 18 being designed as a suction gripping mechanism. The suction gripping mechanism contains a plurality of suction grippers which are likewise fastened to the tool carrier unit 28 at a distance apart. The carrier unit 28 is connected by means of the floating mounting 32 to a carrier unit 30 of a manipulating device 12, for example in the form of an assembly robot. The shaped elements 22 are arranged at a distance from one another in the longitudinal direction according to double arrow 36 (FIG. 4) and in the transverse direction according to double arrow 38 (FIG. 5) along a marginal region of the body component 14 in the form of a roof module. The roof module 14 is held by means of the suction grippers of the gripping mechanism 18 and is positioned at the vehicle body 16 while forming desired bearing contact in the marginal region of the roof module 14. The suction grippers of the gripping mechanism 18 can be connected at any desired locations to the body component. 14 in such a way as to be separable in a nondestructive manner.

Furthermore, the assembly tool 10 according to FIGS. 4 and 5 is provided with a clamping mechanism 54 which is connected to the carrier unit 30 of the manipulating device 12 and by means of which, in cooperation with the gripping mechanism 18 and the positioning mechanism 20, when the floating mounting 32 is activated, the pre-positioned roof module 14 can be pressed against the vehicle body 16 for producing correct bearing contact with the vehicle body 16 in the marginal regions of the roof module 14. To this end, the clamping mechanism 54 is movable relative to the assembly tool 10 according to double arrow 56 when floating mounting 52 is activated. In FIGS. 4 and 5, the clamping mechanism 54 is shown in an active operating position; however, if required, it can be rotated about a suitable pivot axis into a rest position, in which the clamping mechanism 54 constitutes no impediment during pre-positioning of the body component 14 in an immediate vicinity of the vehicle body 16. The further design and functioning of the assembly tool 10 in FIGS. 4 and 5 corresponds to that of the embodiment in FIGS. 1 to 3. Here, if appropriate, the individually described distinguishing features of the respective embodiments can be transferred to the other corresponding embodiment.

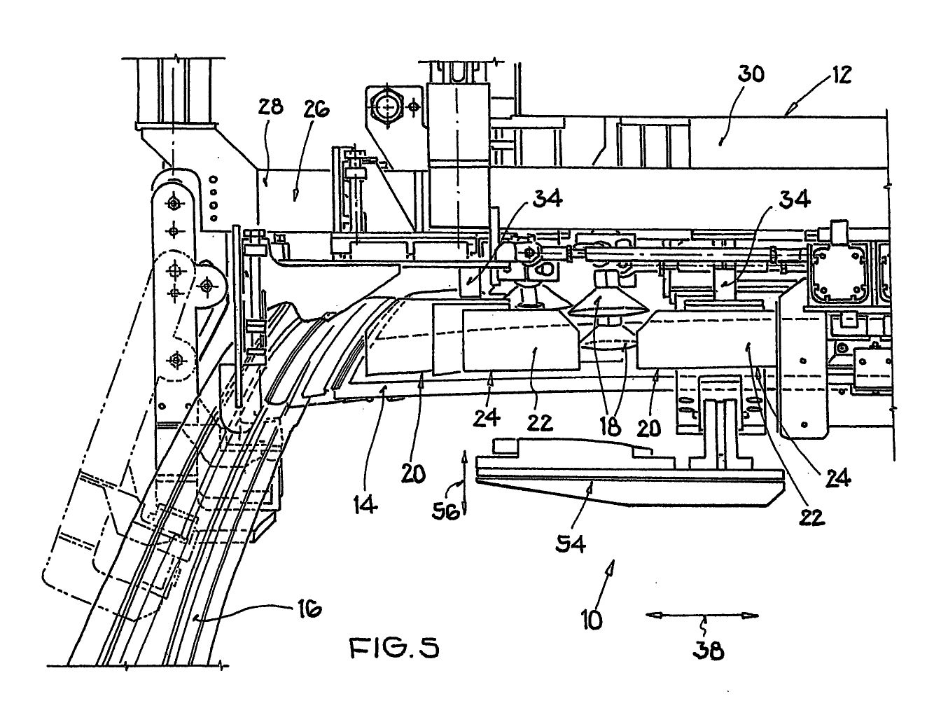

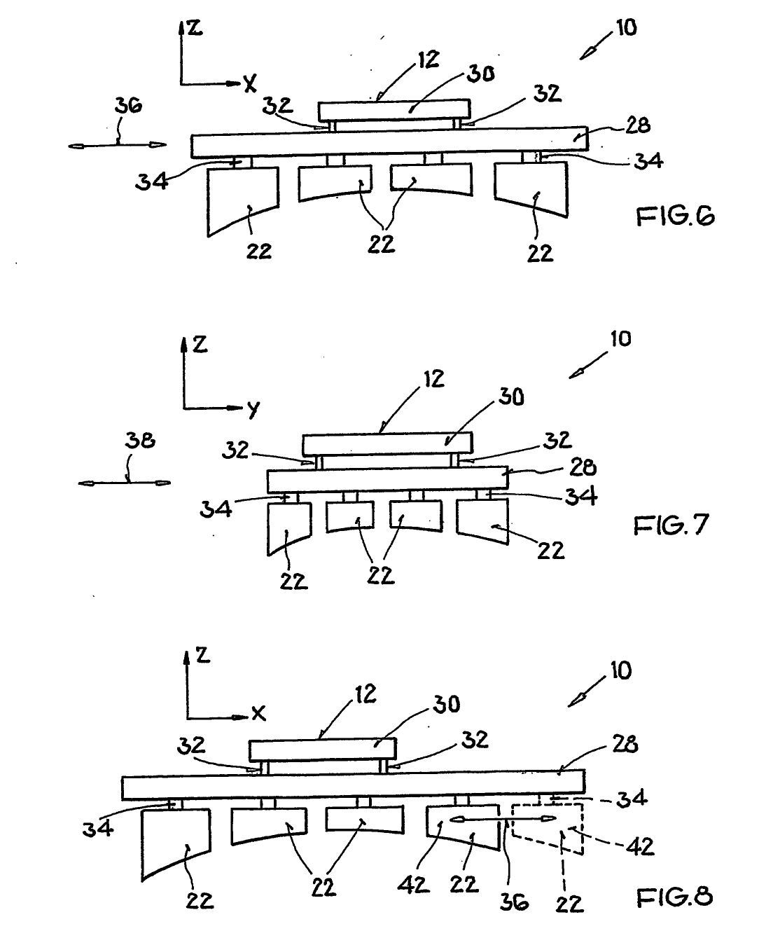

FIGS. 6 and 7 show a longitudinal view and a transverse view, respectively, of an assembly tool 10 according to the invention in one possible embodiment. Here, the assembly tool 10 contains a frame-shaped tool carrier unit 28, which is connected by means of a floating mounting 32 to a likewise frame-shaped carrier unit 30 of a manipulating device 12. In this case, the X direction corresponds to the longitudinal direction of the assembly tool 10 or of the body component 14 (double arrow 36 in FIG. 6), whereas the Y direction in FIG. 7 corresponds to the transverse direction of the assembly tool 10 or for the body part 14 (double arrow 38). The Z direction shown in FIGS. 6 and 7 is parallel to the indeed direction of the body component 14 to be brought into bearing contact with the vehicle body 16 by means of the assembly tool 10 and the manipulating device 12” (see also FIGS. 1 to 5). In this third embodiment, the shaped elements 22 are interchangeably fastened to the tool carrier unit 28 with a respective spring lever 34 in between.

FIG. 8 shows a fourth exemplary embodiment of an assembly tool 10 according to the invention which has a shaped element 22 which can be displaced in position according to double arrow 36. This shaped element 22 is located in a first active operating position (active shaped element 42) and can be moved, if required, according to double arrow 36 (to the right in FIG. 8) into a second active operating position in accordance with the illustration in broken lines. This displacement of the shaped element 22 achieves a contour change in the entire contact surface of the assembly tool 10 for adapting the same entire contact surface to a contour-changed outer surface of a body component 14, for example of a variant of a vehicle roof module.

Shown in FIG. 9 is a fifth exemplary embodiment of an assembly tool 10 according to the invention which has two shaped-element groups 40 which are each pivotable according to double rotation arrow 56 about an associated rotation axis 58, so that an active shaped element 42 is located in an operating position and an inactive shaped element 44 is located in a rest position. The assembly tool 10 according to this fifth embodiment is therefore provided with shaped elements 22 which are pivotable in position relative to the tool carrier unit 28 with an associated spring lever 34 in between.

In this case, the pivoting movement of the shaped-element group 40 extends by about 90°. Shown in FIG. 10 is an alternative shaped-element group 40 which can likewise be used in the assembly tool 10 in FIG. 9. This shaped-element group 40 is also characterized by two shaped elements 22 which are connected to one another in a rotationally rigid manner and can be pivoted in position according to double rotation arrow 56 about the rotation axis 58. In this case, the pivoting movement of the shaped-element group 40 in FIG. 10 extends by an angle of about 180°.

FIG. 11 shows a sixth alternative embodiment of an assembly tool 10 according to the invention which has a plurality of shaped elements 22 which can be moved in a reciprocating manner according to the double arrows 60 shown and can therefore be moved in each case from an active operating position into an inactive rest position or from an inactive rest position into an active operating position.

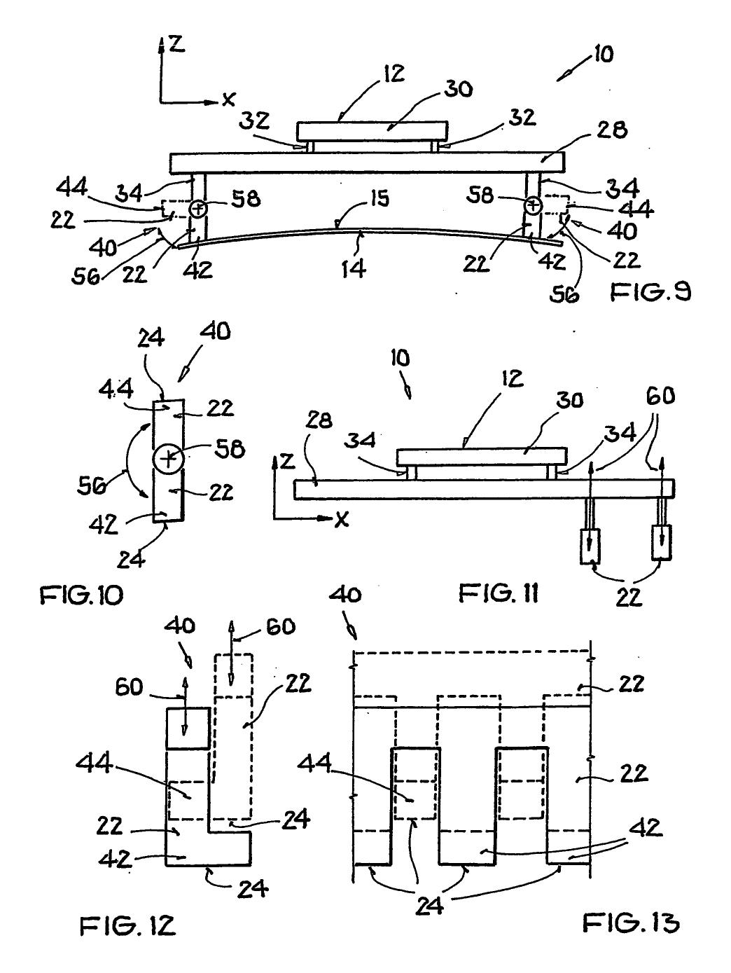

FIGS. 12 and 13 show an alternative shaped-element group 40 which can be adjusted by means of a reciprocating movement. The shaped-element group 40 contains two rake-shaped elements 22 which are arranged in an interlocking manner and can each be moved in a reciprocating manner according to the double arrows 60, so that one shaped element 22 can be located in an active operating position (active shaped element 42) and the other shaped element 22 can be located in an inactive rest position (inactive shaped element 44). The exemplary embodiment in figures 12 and 13 shows that a shaped element 22 may also have a plurality of component contact surfaces 24 at a distance from one another.

To use the assembly tool 10, it is adapted in shape, if appropriate, to the desired component contour by means of a suitable adjustment and/or a suitable exchange of one or more shaped elements 22. The assembly tool 10, which is connected to a manipulating device 12, for example in the form of an assembly robot, is then moved to a body component 14 in order to grip the same in a separable nondestructive manner by means of the gripping mechanism 18 and to locate it in an assembly position at a vehicle body 16 by means of the manipulating device 12 while forming defined bearing contact. In the process, during the transport of the body component 14 by means of the manipulating device 12, the body component 14, if need be, can hang down from the shaped elements 22 at a distance apart on account of the acting gravitational force, as shown in FIG. 1, since the body component 14 is held merely by the gripping mechanism 18, in particular in the form of individual suction grippers. When producing the bearing contact between the body component 14 and the vehicle body 16, the component contact surfaces 24 of a respective, shaped component 22 come into contact with the outer surface of the body component 14, since the body component 14 is pressed against the vehicle body 16 when the clamping mechanism 54 is activated. On account of the floating mounting 32, when the clamping mechanism 54 is activated, the shaped elements 22 are moved toward the body component 14 located in the assembly position, so that the component contact surfaces 24 of the shaped elements 22 ensure that a desired assembly position of the body component 14 at the vehicle body 16 is assumed. In the case of an adhesive connection between the body component 14 and the vehicle body 16, the contact between the shaped elements 22 and the outer surface of the body component 14 ensures that a defined adhesive-bead pressing force is initiated in the body component 14. In this way, a correct and reliable adhesive connection between the body component 14 and the vehicle body 16 is ensured. In this case, the shaped elements 22 connected to the tool carrier unit 28 by means of the spring levers 34 are suitable for flexibly compensating for tolerances of form and/or position, which are possibly present, of the body component 14 or of the vehicle body 16 on account of a corresponding movement of the body component 14 approaching the outer surface 15 against an elastic restoring force of the spring levers 34. Furthermore, the component contact surfaces 24 of the shaped elements 22 ensure that relatively low specific surface forces are initiated in the body component 14 during the pressing of the adhesive and thus no damage is caused to the body component 14 as a result. This can be especially important if, for example, the body component 14 is painted on its outer surface or is a glass roof module.

The assembly tool 10 can be used in a flexible manner for body components of different shape and therefore simplifies the assembly of modular body component variants. Efficient assembly concepts of reliable quality can be realized by means of the assembly tool 10, for the assembly tool can be used in assembly as a combination tool in conjunction with traditional installation robots. If need be, further functions can also be fulfilled by means of the correspondingly modified assembly tool 10 without considerable extra cost, such as, for example, the function for bonding a component. The assembly tool 10 therefore enables body components to be built up to the exact size, such as roof modules for example, since the desired geometry of a body component can be reproduced at the segmented shaped elements 22.

1. An assembly tool (10) for a manipulating device (12) for positioning a body component (14) at a vehicle body (16) while forming bearing contact, the assembly tool (10) comprising:
a gripping mechanism (18), and
a positioning mechanism (20),
wherein the positioning mechanism (20) is suitable for initiating a bearing force in the body component (14),
wherein the positioning mechanism (20) contains at least one shaped element (22) having a component contact surface (24) which is adapted in shape with regard to a desired component contour for forming bearing contact, favorable for fastening, between the body component (14) and the vehicle body (16),
wherein at least one shaped element (22) is displaceable and/or pivotable in position relative to a shaped-element carrier system (26), and
wherein the shaped-element carrier system (26) has a tool carrier unit (28), to which the shaped elements (22) are fastened and which in turn is mounted in a floating manner on a carrier unit (30) of the manipulating device (12), it being possible for the floating mounting (32) to be activated and deactivated.

2. The assembly tool as claimed in claim 1, wherein the contour of the component contact surface (24) of the shaped element (22) corresponds to the outer surface contour of a ready-assembled body component (14).

3. The assembly tool as claimed in claim 1, wherein the shaped element (22) is arranged in an adjustable and/or interchangeable manner in the positioning mechanism (20) for adapting the contour of the assembly tool (10) to geometrically different designs of the body component (14).

4. The assembly tool as claimed in claim 1, wherein the positioning mechanism (20) has a plurality of shaped elements (22) arranged at a distance from one another.

5. (canceled)

6. (canceled)

7. (canceled)

8. The assembly tool as claimed in claim 7, wherein the shaped elements (22) are connected to the tool carrier unit (28) by means of at least one spring element (34).

9. The assembly tool as claimed in claim 8, wherein the tool carrier unit (28) and the carrier unit (30) of the manipulating device (12) are each designed as a frame extending in the longitudinal direction (36) and the transverse direction (38) of the assembly tool (10).

10. The assembly tool as claimed in claim 1, wherein at least two shaped elements (22) are connected to one another while forming a shaped-element group (40), it being possible for one shaped element (42) to be located in an active operating position and the other shaped element (44) in a passive rest position by means of a suitable adjusting movement of the shaped-element group (40).

11. The assembly tool as claimed in claim 10, wherein the adjusting movement of the shaped-element group (40) is a pivoting movement and/or a reciprocating movement.

12. The assembly tool as claimed in claim 10, wherein the shaped elements (22) form a shaped-element row and are arranged relative to one another in a longitudinal direction (36) conforming to the component and/or in a transverse direction (38) conforming to the component.

13. The assembly tool as claimed in claim 1, wherein the shaped elements (22) are stop elements for producing a defined adhesive-bead pressing force when surface contact is produced between the component contact surface (24) and the outer surface (15) of the body component (14) to be adhesively connected to the vehicle body (16).

14. The assembly tool as claimed in claim 1, wherein it has an adjusting mechanism for the automated adaptation of the contour of the component contact surface (24) by assuming a defined active operating position.

15. The assembly tool as claimed in claim 1, wherein the gripping mechanism (18) is a suction gripping mechanism.

16. The assembly tool as claimed in claim 1, wherein said assembly tool is a roof-module assembly tool.

17. A manipulating device for positioning a body component (14) at a vehicle body (16) while forming bearing contact, the assembly tool (10) comprising:
a gripping mechanism (18), and
a positioning mechanism (20),
wherein the positioning mechanism (20) is suitable for initiating a bearing force in the body component (14),
wherein the positioning mechanism (20) contains at least one shaped element (22) having a component contact surface (24) which is adapted in shape with regard to a desired component contour for forming bearing contact, favorable for fastening, between the body component (14) and the vehicle body (16),
wherein at least one shaped element (22) is displaceable and/or pivotable in position relative to a shaped-element carrier system (26), and
wherein the shaped-element carrier system (26) has a tool carrier unit (28), to which the shaped elements (22) are fastened and which in turn is mounted in a floating manner on a carrier unit (30) of the manipulating device (12), it being possible for the floating mounting (32) to be activated and deactivated, and
wherein said manipulating device (12) is an assembly robot.
